(19) United States
(12) Patent Application Publication
(10) Pub. No.: US 2026/0159630 A1
(43) Pub. Date: Jun. 11, 2026

(54) NICKEL CATALYST AND USE THEREOF FOR THE PREPARATION OF POLYETHER SILICONE COPOLYMERS

(71) Applicant: SHANGHAI MENHOVER CHEMICAL COMPANY LIMITED, Shanghai (CN)

(72) Inventors: Wenkai ZHANG, Shanghai (CN); Yechen LE, Shanghai (CN); Yulin WU, Shanghai (CN); Danfeng CAO, Shanghai (CN)

(21) Appl. No.: 19/141,479

(22) PCT Filed: Sep. 5, 2024
(86) PCT No.: PCT/CN2024/117168

§ 371 Date: Jun. 20, 2025

(51) Int. Cl. C08G 18/22; C08G 18/48; C08G 77/46; C08J 9/00

(52) U.S. Cl. CPC C08G 18/222; C08G 18/48; C08G 77/46; C08J 9/0061; C08J 2375/08

(57) ABSTRACT

The present invention belongs to the field of chemical industry and specifically relates to a nickel complex containing a long alkyl chain, and application thereof in the preparation of polyether silicone copolymer. This new catalyst has a convenient source and low cost, with a price that is one percent of that of conventional platinum/palladium catalyst. In addition, the catalyst contains a silicon-based structure and has good compatibility with hydrogen-containing polysiloxane, enabling full contact with hydrogen-containing polysiloxane and allyl polyether, thereby efficiently catalyzing the reaction between the two to prepare a polyether silicone copolymer. The resulting silicone copolymer is particularly suitable as a foam stabilizer for polyurethane foam, especially as a foam stabilizer in mechanically whipped polyurethane foaming process.

### TECHNICAL FIELD

The present invention belongs to the field of chemical industry and specifically relates to a nickel complex containing a long alkyl chain, and application thereof in the preparation of polyether silicone copolymer.

### BACKGROUND ART

Polyether silicone copolymer is a surfactant with a novel structure, and the unique molecular structure thereof comprises both polysiloxane and polyether. Among them, the polysiloxane part endows the surfactant with characteristics such as low surface tension, anti-static, physiological inertness, and the like. By adjusting the polymerization degree and ratio of epoxy ethane (EO) and epoxy propane (PO) in polyether, as well as the ratio of polyether and polysiloxane, silicone surfactants with different properties and applications may be obtained, which may be widely used in industries such as coatings, polyurethane, pesticides, and daily chemical industry.

The key reaction for the preparation of polyether silicone copolymer is the addition reaction of hydrogen-containing polysiloxane and allyl polyether. This reaction generally uses inorganic platinum salt catalyst, which has poor lipid solubility and often has insufficient contact with the hydrogen-containing polysiloxane during the reaction, thus affecting the reaction efficiency. Additionally, platinum catalysts are relatively expensive, significantly increasing the production cost.

### SUMMARY

To overcome the defects of the prior art, the present invention provides a method for preparing a nickel catalyst and application thereof in the preparation of polyether silicone copolymer.

Firstly, a polyether, an ethyl orthosilicate, and a carboxyethylsilanetriol sodium salt undergo a chemical reaction, and the resulting product is acid washed to obtain a catalyst intermediate. Then, the intermediate reacts with a nickel salt to obtain the corresponding nickel complex catalyst.

The polyether is selected from polyethylene oxide, polypropylene oxide, or their copolymers, each having a molecular weight of 2000 to 6000. The nickel salt is selected from nickel chloride, nickel nitrate, nickel bromide, etc.

On the other hand, the above-mentioned nickel catalyst is used to prepare a polyether silicone copolymer. Weighing a hydrogen-containing polysiloxane and an allyl polyether in a molar ratio of 1.0:(1.0-1.1), then adding the nickel complex containing a long alkyl chain as mentioned above, wherein the amount of the nickel complex is 1-5% of the amount of the hydrogen-containing polysiloxane. Finally, the hydrogen-containing polysiloxane and the allyl polyether undergo a hydrosilylation reaction under the catalysis of the nickel complex to obtain a polyether silicone copolymer.

The allyl polyether is selected from allyl polyethers with a molecular weight of 500-2400.

Furthermore, the allyl polyether is selected from allyl polyethers with a molecular weight of 580, 700, 800, 900, 1000, 2000 or 2400.

### Beneficial Effects

The present invention provides a method for preparing a nickel complex catalyst, which is a new catalyst with convenient source and low cost, and the price thereof is one percent of that of general platinum/palladium catalysts. In addition, this catalyst contains a silicon-based structure and has good compatibility with the hydrogen-containing polysiloxane, which allows for fully contact with the hydrogen-containing polysiloxane and the allyl polyether, thereby efficiently catalyzing the reaction between the two to prepare the polyether silicone copolymer. The resulting silicone copolymer is particularly suitable as the foam stabilizer for polyurethane foam, especially as the foam stabilizer in mechanically whipped polyurethane foaming process. In summary, the method has inexpensive reagents, simpler formulations, more convenient operations, and is green, safe, efficient, and environmentally friendly, making it suitable for industrial production.

### DESCRIPTION OF DRAWINGS

FIG. 1 shows the high-resolution XPS images of catalysts C2 and C8.

### DETAILED DESCRIPTIONS

### Preparation of Nickel Complex Catalyst (General Step 1):

Step 1:2 g of polyether was dissolved in 60 g of 2 mol/L hydrochloric acid. The resulting solution was stirred at 50° C. for 4 hours. Then, a solution containing 24 g of carboxyethylsilanetriol sodium salt and 96 g of ethyl orthosilicate was added dropwise thereto. After the dropwise addition was complete, the solution was stirred at 50° C. for another 12 hours. The obtained white suspension was aged at 100° C. for 24 hours, filtered, and the filter cake was washed with deionized water and dried to obtain a white solid.

Step 2: 1 g of the white solid obtained above was taken and dispersed in 250 ml of 48 wt % sulfuric acid. The resulting mixture was stirred at 100° C. for 24 hours, filtered, and the filter cake was washed with deionized water and dry to obtain a catalyst intermediate.

Step 3: 0.5 g of the catalyst intermediate obtained above was taken and dispersed in 50 ml of 0.05M nickel salt solution. Under continuous stirring, 0.1M sodium hydroxide solution was added dropwise thereto to achieve a pH of 9. At this point, a light green solid was precipitate, filtered, and the filter cake was washed with deionized water and dry to obtain a light green solid. Furthermore, the solid was calcined at 600° C. in a mixed gas atmosphere of argon and hydrogen (95:5) for 8 hours, then cooled to obtain a target catalyst, and was stored in a vacuum drying oven.

### Preparation of Polyether Silicone Copolymer by Reaction of Hydrogen-Containing Polysiloxane and Allyl Polyether (General Step 2):

In a reaction vessel, hydrogen-containing polysiloxane (with a silicon hydrogen content of 0.18% and a viscosity of 10-20cp) and allyl polyether were added in a molar ratio of 1:1. Then, 1 wt % of the aforementioned nickel complex M was added, heated to 80-100° C. and reacted for 6-8 hours to obtain a polyether silicone copolymer.

### Example 1: Preparation of Nickel Complex C1

According to General Step 1, the polyether was selected from polyethylene oxide with a molecular weight of 2000, and nickel bromide was used as the nickel salt to prepare 0.694 g of nickel complex C1, the yield was 82%.

### Example 2: Preparation of Nickel Complex C2

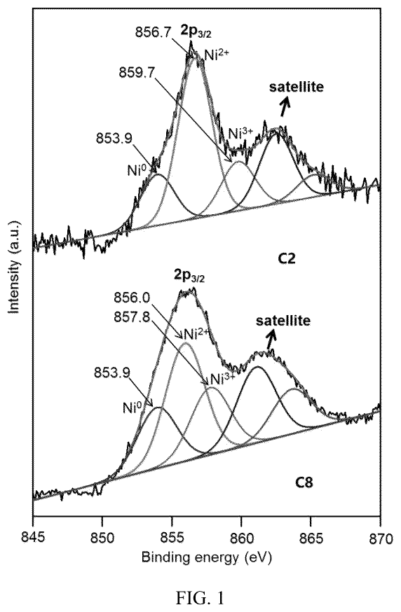

According to General Step 1, the polyether was selected from polyethylene oxide with a molecular weight of 4000, and nickel chloride was used as the nickel salt to prepare 0.625 g of nickel complex C2, the yield was 85%. The characterization data was shown in FIG. 1.

### Example 3: Preparation of Nickel Complex C3

According to General Step 1, the polyether was selected from polyethylene oxide with a molecular weight of 6000, and nickel nitrate was used as the nickel salt to prepare 0.698 g of nickel complex C3, the yield was 87%.

### Example 4: Preparation of Nickel Complex C4

According to General Step 1, the polyether was selected from polypropylene oxide with a molecular weight of 2000, and nickel bromide was used as the nickel salt to prepare 0.728 g of nickel complex C4, the yield was 86%.

### Example 5: Preparation of Nickel Complex C5

According to General Step 1, the polyether was selected from polypropylene oxide with a molecular weight of 4000, and nickel chloride was used as the nickel salt to prepare 0.596 g of nickel complex C5, the yield was 81%.

### Example 6: Preparation of Nickel Complex C6

According to General Step 1, the polyether was selected from polypropylene oxide with a molecular weight of 6000, and nickel nitrate was used as the nickel salt to prepare 0.665 g of nickel complex C6, the yield was 83%.

### Example 7: Preparation of Nickel Complex C7

According to General Step 1, the polyether was selected from ethylene oxide-propylene oxide copolymer with a molecular weight of 2000, and nickel bromide was used as the nickel salt to prepare 0.677 g of nickel complex C7, the yield was 80%.

### Example 8: Preparation of Nickel Complex C8

According to General Step 1, the polyether was selected from ethylene oxide-propylene oxide copolymer with a molecular weight of 4000, and nickel chloride was used as the nickel salt to prepare 0.603 g of nickel complex C8, the yield was 82%. The characterization data was shown in FIG. 1.

### Example 9: Preparation of Nickel Complex C9

According to General Step 1, the polyether was selected from ethylene oxide-propylene oxide copolymer with a molecular weight of 6000, and nickel nitrate was used as the nickel salt to prepare 0.705 g of nickel complex C9, the yield was 88%.

### Example 10: Reaction of Hydrogen-Containing Polysiloxane and Allyl Polyether with Molecular Weight of 580

According to General Step 2, an allyl polyether with a molecular weight of 580 was used as the allyl polyether, and complex C1 was used as the catalyst, to prepare the corresponding polyether silicone copolymer P1.

### Example 11: Reaction of Hydrogen-Containing Polysiloxane and Allyl Polyether with Molecular Weight of 700

According to General Step 2, an allyl polyether with a molecular weight of 700 was used as the allyl polyether, and complex C2 was used as the catalyst, to prepare the corresponding polyether silicone copolymer P2.

### Example 12: Reaction of Hydrogen-Containing Polysiloxane and Allyl Polyether with Molecular Weight of 800

According to General Step 2, an allyl polyether with a molecular weight of 800 was used as the allyl polyether, and complex C3 was used as the catalyst, to prepare the corresponding polyether silicone copolymer P3.

### Example 13: Reaction of Hydrogen-Containing Polysiloxane and Allyl Polyether with Molecular Weight of 900

According to General Step 2, an allyl polyether with a molecular weight of 900 was used as the allyl polyether, and complex C4 was used as the catalyst, to prepare the corresponding polyether silicone copolymer P4.

### Example 14: Reaction of Hydrogen-Containing Polysiloxane and Allyl Polyether with Molecular Weight of 1000

According to General Step 2, an allyl polyether with a molecular weight of 1000 was used as the allyl polyether, and complex C5 was used as the catalyst, to prepare the corresponding polyether silicone copolymer P5.

### Example 15: Reaction of Hydrogen-Containing Polysiloxane and Allyl Polyether with Molecular Weight of 2000

According to General Step 2, an allyl polyether with a molecular weight of 2000 was used as the allyl polyether, and complex C6 was used as the catalyst, to prepare the corresponding polyether silicone copolymer P6.

### Example 16: Reaction of Hydrogen-Containing Polysiloxane and Allyl Polyether with Molecular Weight of 2400

According to General Step 2, an allyl polyether with a molecular weight of 2400 was used as the allyl polyether, and complex C7 was used as the catalyst, to prepare the corresponding polyether silicone copolymer P7.

### Example 17: Reaction of Hydrogen-Containing Polysiloxane and Allyl Polyether with Molecular Weight of 2400

According to General Step 2, an allyl polyether with a molecular weight of 2400 was used as the allyl polyether, and complex C8 was used as the catalyst, to prepare the corresponding polyether silicone copolymer P8.

### Example 18: Reaction of Hydrogen-Containing Polysiloxane and Allyl Polyether with Molecular Weight of 2400

According to General Step 2, an allyl polyether with a molecular weight of 2400 was used as the allyl polyether, and complex C9 was used as the catalyst, to prepare the corresponding polyether silicone copolymer P9.

### Example 19: Reaction of Hydrogen-Containing Polysiloxane and Allyl Polyether with Molecular Weight of 700

According to General Step 2, an allyl polyether with a molecular weight of 700 was used as the allyl polyether, and complex C5 was used as the catalyst, to prepare the corresponding polyether silicone copolymer P10.

### Example 20: Reaction of Polysiloxane and Allyl Polyether with Molecular Weight of 700

According to General Step 2, an allyl polyether with a molecular weight of 700 was used as the allyl polyether, and complex C8 was used as the catalyst, to prepare the corresponding polyether silicone copolymer P11.

Physical properties of the polyether silicone copolymers P2, P10, and P11 prepared using the catalysts C2, C5, and C8 were measured. The control group was a silicone copolymer prepared by using nickel acetylacetonate as the catalyst, and according to General Step 2, using an allyl polyether with a molecular weight of 700 as the allyl polyether. The test results are shown in Table 1:

TABLE 1

| | | Testing | Control | | | |
|---|---|---|---|---|---|---|
| Item | Unit | Standard | Group | P2 | P10 | P11 |
| Complete | minute | — | 351 | 198 | 225 | 187 |
| conversion time | | | | | | |
| Density | kg/m³ | GB/T 6343 | 33.5 | 39.6 | 39.7 | 39.8 |
| Compressive | kPa | GB/T 8813 | 139.8 | 189.5 | 193.2 | 195.4 |
| strength | | | | | | |
| Adhesive strength | kPa | GB/T 2791 | 112.3 | 129.1 | 128.6 | 127.3 |
| Dimensional | % | GB/T 8811 | 1.43 | 1.59 | 1.68 | 1.68 |
| stability | | | | | | |
| Thermal | W/m · k | GB/T 10295 | 0.0293 | 0.0297 | 0.0298 | 0.0297 |
| conductivity | | | | | | |

From the above test results, compared to conventional nickel acetylacetonate, the catalyst of the present invention reacted faster, and the raw materials may be completely converted in a shorter time. At the same time, it may significantly enhance the key properties of the polyether silicone copolymer and fully demonstrate the superiority of this nickel catalyst.

In addition, it was found that the polyether silicone copolymer prepared by the catalyst of the present invention has excellent foam cell stability and less catalyst amount when air was whipped into the polyurethane system.

Example 21: 5 parts of silicone copolymer P7 were added to a combination of 100 parts of polyether polyol A (trifunctional, hydroxyl value of 35) and 10 parts of dipropylene glycol. 2 parts of nickel acetylacetonate solution (10% concentration) were added as catalyst, and 25 parts of crude MDI were used for crosslinking. After whipping air into the system for 5 minutes, the overall density may be reduced to 620 g/L. The system had a room-temperature operation time of 2 hours and a curing time of 5 minutes at 120° C.

Example 22: 5 parts of silicone copolymer P8 were added to a combination of 100 parts of polyether polyol A (trifunctional, hydroxyl value of 35) and 10 parts of dipropylene glycol. 2 parts of nickel acetylacetonate solution (10% concentration) were added as catalyst, and 25 parts of crude MDI were used for crosslinking. After whipping air into the system for 5 minutes, the overall density may be reduced to 610 g/L. The system had a room-temperature operation time of 2 hours and a curing time of 5 minutes at 120° C.

Example 23: 2.5 parts of silicone copolymer P8 and 2.5 parts of a high-molecular-weight silicone block copolymer (Menhover S-9164) were added to a combination of 100 parts of polyether polyol A (trifunctional, hydroxyl value of 35) and 10 parts of dipropylene glycol. 2 parts of nickel acetylacetonate solution (10% concentration) were added as catalyst, and 25 parts of crude MDI were used for crosslinking. After whipping air into the system for 5 minutes, the overall density may be reduced to 480 g/L. The system had a room-temperature operation time of 2.5 hours and a curing time of 7 minutes at 120° C.

Comparative Example 1:5 parts of organic silicon copolymer Menhover S-193 were added to a combination of 100 parts of polyether polyol A (trifunctional, hydroxyl value of 35) and 10 parts of dipropylene glycol. 2 parts of nickel acetylacetonate solution (10% concentration) were added as catalyst, and 25 parts of crude MDI were used for crosslinking. After whipping air into the system for 5 minutes, the overall density may be reduced to 980 g/L. The system had a room-temperature operation time of 3 hours and a curing time of 10 minutes at 120° C.

1. A method for preparing a nickel complex catalyst, wherein firstly, a polyether, an ethyl orthosilicate, and a carboxyethylsilanetriol sodium salt undergo a chemical reaction, the resulting product is acid washed to obtain a catalyst intermediate; and then, the intermediate reacts with a nickel salt to obtain the corresponding nickel complex catalyst.

2. The method for preparing a nickel complex catalyst according to claim 1, wherein the polyether is selected from polyethylene oxide, polypropylene oxide, or their copolymers, each having a molecular weight of 2000 to 6000.

3. The method for preparing a nickel complex catalyst according to claim 1, wherein the nickel salt is selected from nickel chloride, nickel nitrate or nickel bromide.

4. A method for preparing a polyether silicone copolymer, wherein the nickel complex according to claim 1 is used as a catalyst, and the steps include: weighing a hydrogen-containing polysiloxane and an allyl polyether in a molar ratio of 1.0:(1.0-1.1), then adding the nickel complex, wherein the amount of the nickel complex is 1-5% of the amount of the hydrogen-containing polysiloxane; finally, the hydrogen-containing polysiloxane and the allyl polyether undergo a hydrosilylation reaction under the catalysis of the nickel complex to obtain the polyether silicone copolymer.

5. The method, according to claim 4, wherein the allyl polyether is selected from allyl polyethers with a molecular weight of 500-2400.

6. The method according to claim 4, wherein the allyl polyether is selected from allyl polyethers with a molecular weight of 580, 700, 800, 900, 1000, 2000 or 2400.

7. Use of a polyether silicone copolymer prepared by the method according to claim 4 as a foam stabilizer in polyurethane foaming.

8. The use according to claim 7, wherein the foam stabilizer is applied in mechanically whipped polyurethane foaming process.
